(19) United States
(12) Patent Application Publication
(10) Pub. No.: US 2014/0052370 A1
(43) Pub. Date: Feb. 20, 2014

(54) MOBILE-BODY NAVIGATION DEVICE AND MOBILE-BODY NAVIGATION SYSTEM

(71) Applicants: Masashi Watanabe, Tokyo (JP); Takashi Tamada, Tokyo (JP); Mitsuo Shimotani, Tokyo (JP); Hidekazu Arita, Tokyo (JP)

(72) Inventors: Masashi Watanabe, Tokyo (JP); Takashi Tamada, Tokyo (JP); Mitsuo Shimotani, Tokyo (JP); Hidekazu Arita, Tokyo (JP)

(73) Assignee: MITSUBISHI ELECTRIC CORPORATION, Tokyo (JP)

(21) Appl. No.: 14/111,981

(22) PCT Filed: May 27, 2011
(86) PCT No.: PCT/JP2011/002976

§ 371 Date: Oct. 15, 2013

(51) Int. Cl. G01C 21/36

(52) U.S. Cl. CPC G01C 21/3626
USPC 701/428; 701/517; 701/537

(57) ABSTRACT

A mobile-body navigation device includes a communication device 7 and a communication interface unit 9, which constitute a receiving unit for receiving information about a deviation-prone connection route identified using probe information, a deviation-prone connection route caution instructing unit 14 for instructing to send a notification when a vehicle approaches a deviation-prone point on the guide route in accordance with the information about the deviation-prone connection route the receiving unit receives, and a display device 8 and a map display unit 13, which constitute a display unit for displaying a guide map of the guide route in response to the instruction.

### TECHNICAL FIELD

The present invention relates to a mobile-body navigation device for providing a user with a deviation-prone route from a recommended route, and to a mobile-body navigation system using the device.

### BACKGROUND ART

For example, a server disclosed in Patent Document 1 collects from a plurality of vehicles data about a deviation or return from a first recommended route, analyzes driving path data from the deviation point to the return point from the data collected, and obtains the optimum route, which matches better to real road conditions than the first recommended route that is calculated by a navigation device, as expert route data to share the data among a plurality of users.

### PRIOR ART DOCUMENT

Patent Document 1: Japanese Patent Laid-Open No. 2010-237178.

### DISCLOSURE OF THE INVENTION

### Problems to be Solved by the Invention

Conventional techniques typified by the Patent Document 1 assume that a user deviates from the recommended route intentionally, and do not consider a case of an unexpected route departure due to a mistake of the user. Accordingly, they cannot provide the user with a deviation-prone route, thereby offering a problem of being unable to make appropriate route guidance at a connection point of the route.

The present invention is implemented to solve the foregoing problem. Therefore it is an object of the present invention to provide a mobile-body navigation device capable of making appropriate route guidance at a deviation-prone connection route that can misleads the user frequently, and a mobile-body navigation system using that device.

### Means to Solve the Problem

A mobile-body navigation device in accordance with the present invention comprises a receiving unit for receiving information about a deviation-prone connection route on a route identified using probe information, an instructing unit for instructing to send a notification when a mobile-body approaches a deviation-prone point on a guide route in accordance with the information about the deviation-prone connection route the receiving unit receives, and a display unit for displaying a guide map of the guide route in response to the instruction.

Here, the term “deviation-prone connection route” refers to a route that can mislead a driver frequently, and the term “deviation-prone point” refers to a point (such as an intersection) on the deviation-prone connection route, which can mislead the driver into a wrong route. When passing through a deviation-prone point on a deviation-prone connection route from a route other than the deviation-prone connection route, the deviation-prone point is not reckoned as a deviation-prone point.

### Advantages of the Invention

According to the present invention, it offers an advantage of being able to make appropriate route guidance at the deviation-prone connection route that can mislead the user frequently.

### BRIEF DESCRIPTION OF THE DRAWINGS

FIG. 1 is a block diagram showing a configuration of a mobile-body navigation system of an embodiment 1 in accordance with the present invention;

FIG. 2 is a diagram showing registered contents of a probe DB;

FIG. 3 is a flowchart showing the route guidance processing of the mobile-body navigation system of the embodiment 1;

FIG. 4 is a diagram showing an example of a guide map near a deviation-prone point; and

FIG. 5 is a diagram showing another example of a guide map near a deviation-prone point.

### BEST MODE FOR CARRYING OUT THE INVENTION

The best mode for carrying out the invention will now be described with reference to the accompanying drawings to explain the present invention in more detail.

### Embodiment 1

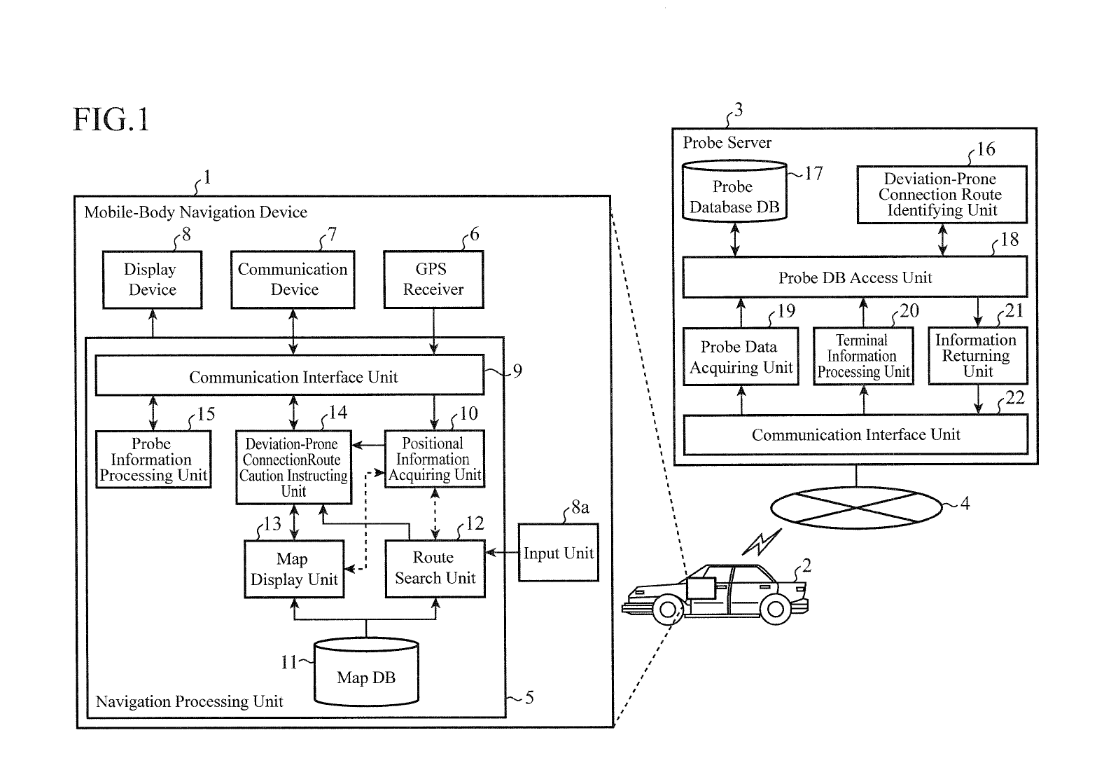

FIG. 1 is a block diagram showing a configuration of a mobile-body navigation system of an embodiment 1 in accordance with the present invention. In FIG. 1, the mobile-body navigation system of the embodiment 1 comprises a mobile-body navigation device 1 mounted in a mobile body (vehicle 2, for example) and a probe server 3. The mobile-body navigation device 1, which is installed in the vehicle 2, is a navigation device that is capable of communicating with the probe server 3 via a communication network 4, and that comprises a navigation processing unit 5, a GPS (Global Positioning System) receiver 6, a communication device 7, a display device 8, and an input unit 8a.

In the foregoing configuration, the GPS receiver 6 is a receiver for receiving GPS radio waves for locating the vehicle from GPS satellites, and the communication device 7, which is a communication device for communicating with the probe server 3 via the communication network 4, operates as a receiving unit for receiving from the probe server 3 information about a deviation-prone connection route on the route. It corresponds to a communication processing module incorporated into the mobile-body navigation device 1 or to a mobile phone connected to the mobile-body navigation device 1, for example.

In addition, the display device 8, which is a display device for displaying on its screen the information acquired by the processing of the navigation processing unit 5, carries out display of various menu images, map display by a map display unit 13, and display of a guide map including the deviation-prone connection route instructed by a deviation-prone connection route caution instructing unit 14. The input unit 8a, which is a component for receiving a setting input of a destination or various operation of a user, is realized by a touch screen mounted on the screen of the display device 8, for example.

The navigation processing unit 5, which is a component for carrying out navigation processing such as a route search, route guidance and map display, comprises a communication interface unit 9, a positional information acquiring unit 10, a map database (DB) 11, a route search unit 12, a map display unit 13, a deviation-prone connection route caution instructing unit 14, and a probe information processing unit 15.

The communication interface unit 9 is an interface for carrying out communication control of the communication device 7, and for relaying communication between the probe server 3 and the navigation processing unit 5 via the communication network 4.

The positional information acquiring unit 10 is a component for obtaining the positional information (latitude and longitude) of the vehicle from the analysis result of the GPS radio waves received by the GPS receiver 6. The positional information of the vehicle is delivered from the positional information acquiring unit 10 to the navigation processing unit 5. The positional information can be obtained by using sensor information acquired from a vehicle speed sensor, acceleration sensor and angular velocity sensor in addition to the analysis result of the GPS radio waves.

The map DB 11 is a database that records map data to be used by the navigation processing. The map data contains topographic map data, house map data, road network and the like. The route search unit 12 is a component for searching for a recommended route using the destination set through the input unit 8a, the positional information of the vehicle acquired by the positional information acquiring unit 10 and the map data stored in the map DB 11, and for making route guidance based on the recommended route. The map display unit 13 is a component for displaying a map on the screen of the display device 8 using the map data of the map DB 11.

The deviation-prone connection route caution instructing unit 14 is an instructing unit for acquiring information about a deviation-prone connection route of the vehicle from the probe server 3 via the communication network 4, and for instructing the map display unit 13 to display a guide map about the deviation-prone connection route. The probe information processing unit 15 is a component for executing processing using the probe information detected with the sensors mounted in the vehicle. For example, the probe information processing unit 15 uploads the probe information about the vehicle to the probe server 3 via the communication device 7.

The probe server 3, which is a server for collecting and managing the probe information, comprises a deviation-prone connection route identifying unit 16, a probe database (DB) 17, a probe DB access unit 18, a probe data acquiring unit 19, a terminal information processing unit 20, an information returning unit 21 and a communication interface unit 22. The deviation-prone connection route identifying unit 16 is a component for identifying using the probe information registered in the probe DB 19 the deviation-prone connection route due to a mistake of a driver of the vehicle that includes the mobile-body navigation device 1.

The probe DB 17 is a database for recording the probe information detected by an unspecified large number of vehicles. The probe information, which is information indicating the driving path of the vehicle detected by the vehicle during driving, contains the positional information (latitude and longitude) of the vehicle, the time, stoppage time, time and distance to the destination and the like.

The probe DB access unit 18, which is a component for gaining access to the probe DB 17 to exchange probe information, writes the probe information acquired by the probe data acquiring unit 19, and reads from the probe DB 17 the probe information requested by the deviation-prone connection route identifying unit 16, for example. In addition, the probe DB access unit 18 converts the probe information acquired by the probe data acquiring unit 19 to the time required per road link, and writes it in the probe DB 17.

The probe data acquiring unit 19 is a component for acquiring via the communication interface unit 22 the probe information about an unspecified large number of vehicles (probe cars) transmitted via the communication network 4 and for supplying it to the probe DB access unit 18.

The terminal information processing unit 20 is a component for extracting from the information received via the communication interface unit 22 the probe information or route information from the mobile-body navigation device 1 and for outputting it to the probe DB access unit 18.

The information returning unit 21 is a returning unit for sending the deviation-prone connection route identified on the route of the requesting vehicle back to the mobile-body navigation device 1 of the requesting vehicle via the communication interface unit 22. The communication interface unit 22 is an interface for relaying communication between the probe server 3 and an external device (mobile-body navigation device 1, for example) via the communication network 4.

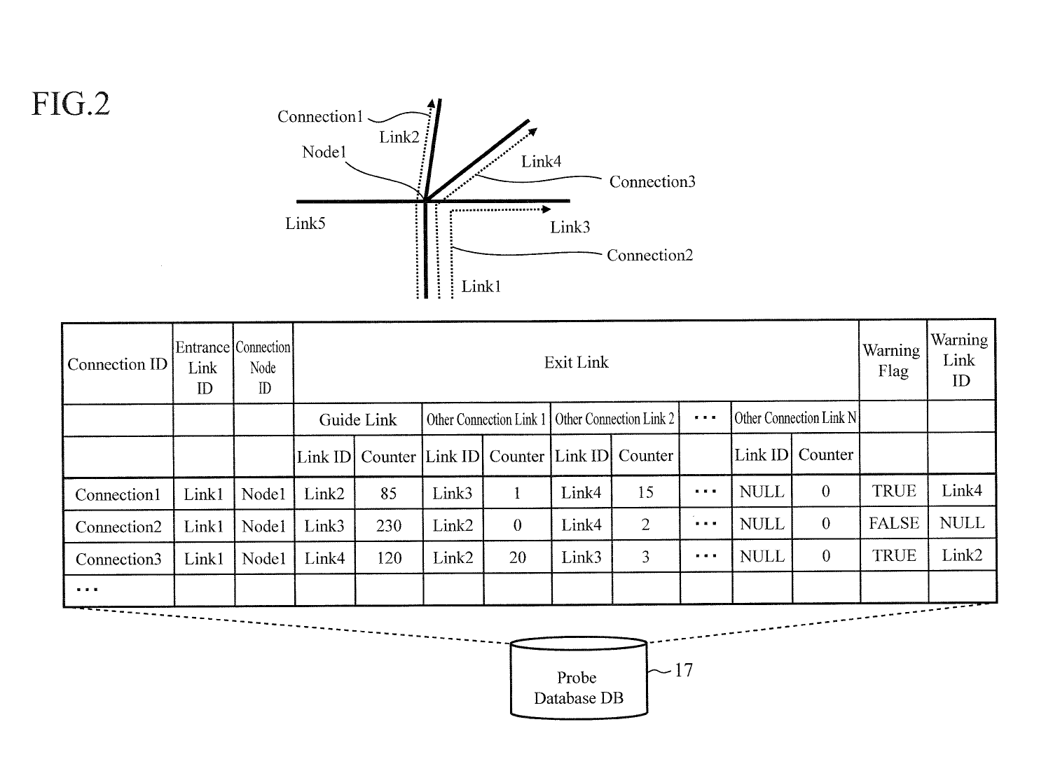

FIG. 2 is a diagram showing registration contents of the probe DB, which shows relationships of connections between road links with the probe information. At the intersection of the guide route, the entrance link to the intersection and a connection ID for each guide link (Connection 1, . . . ) are given.

The probe DB 17 stores for each connection ID the count value of a link indicating a road to which a vehicle acquired from the probe information actually exits from the intersection, information (warning flag) indicating whether it is the deviation-prone connection route identified by the deviation-prone connection route identifying unit 16 or not, and a deviation-prone link ID (referred to as a “warning link ID” from now on). However, even if the exit link from the intersection differs from the guide link, when a decision is made that the deviation from the guide link is intentional, the count-up is not made. As for these information items, they can be retained after dividing them in accordance with a time zone or the weather. This makes it possible to provide appropriate information about a route where a deviation occurs frequently only during the night or only in case of rain.

Here, a case will be described where a deviation is decided as an intentional one.

When the estimated necessary time or estimated distance covered that will be taken by a vehicle which deviates from the guide route to arrive at the destination is less than the estimated necessary time or estimated distance covered that will be obtained when the vehicle does not deviate, or the difference between them is less than a prescribed value, the deviation-prone connection route identifying unit 16 decides that the deviation is intentional because it is likely that the driver makes a decision that the route the driver actually selects is better than the guide route.

In addition, when the vehicle does not arrive at the destination or when it stops or parks for more than a prescribed time period before arriving at the destination, the deviation-prone connection route identifying unit 16 decides that the deviation is intentional because it is likely that the driver deviates from the guide route because of stopping along the way.

Incidentally, these criteria can be combined properly.

The warning flag is TRUE (deviation-prone connection route) when the number of times of exiting along the guide link/the total number of times of guidance<constant k₁ (0<k₁<1), and FALSE (not a deviation-prone connection route) otherwise. Here, k₁ varies depending on the total number of times of guidance. Incidentally, the term “total number of times of guidance” refers to the number of informing of the guide route regardless of the occurrences of the deviation. In addition, the term “number of times of exiting along the guide link” is the number of times of vehicles exiting the intersection along the route of the guide link.

In the warning link ID, is set a set of link IDs that satisfy, among all the links (connection links) connected to the connection node (intersection), the number of times of exiting along the connection link/the total number of times of guidance>constant k₂ (0<k₂<1) as a link ID of the deviation destination. Here, k₂ varies depending on the total number of times of guidance. In addition, among all the connection links connected to the connection node, the link ID that has the maximum value of the number of times of exiting along the connection link/the total number of times of guidance can be set.

Next, the operation will be described.

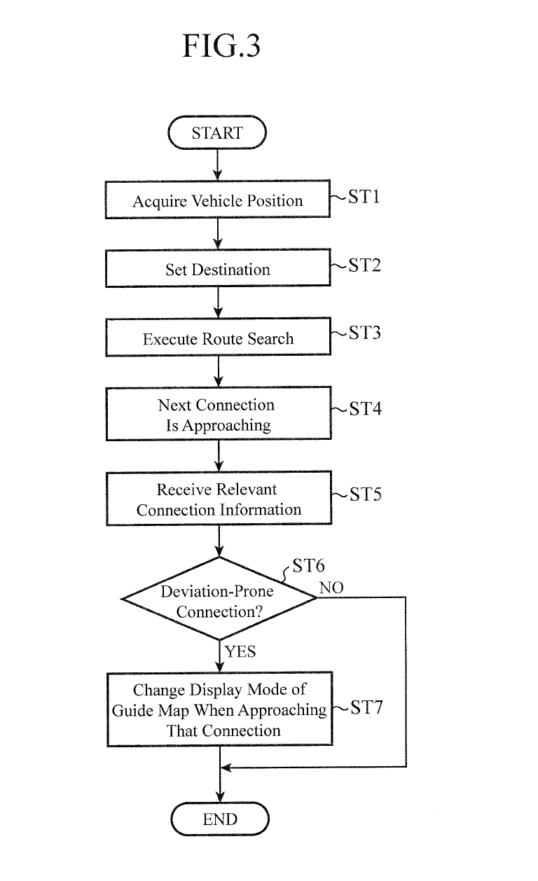

FIG. 3 is a flowchart showing the route search processing of the mobile-body navigation system of the embodiment 1.

First, in the mobile-body navigation device 1, the positional information acquiring unit 10 acquires the positional information (latitude and longitude) of the vehicle (vehicle 2) from the analysis result of the GPS radio waves received by the GPS receiver 6 (step ST1). Then the positional information obtained by the positional information acquiring unit 10 is delivered to the route search unit 12. Then, a user sets a destination to the route search unit 12 using the input unit 8a (step ST2).

The route search unit 12 searches for a recommended route using the destination set via the input unit 8a, the positional information of the vehicle 2 obtained by the positional information acquiring unit 10 and the map data of the map DB 11 (step ST3). Here, when it identifies the starting point using the positional information obtained by the positional information acquiring unit 10, the route search unit 12 calculates the recommended route connecting the starting point to the destination.

When the vehicle, while traveling along the recommended route, comes within a prescribed range (within the estimated arrival time or estimated distance covered) from the next connection point (such as an intersection) (step ST4), the deviation-prone connection route caution instructing unit 14 instructs the communication device 7 to transmit the information about the connection to the probe server 3 via the communication interface unit 9.

Receiving the information about the connection from the mobile-body navigation device 1 (step ST5), the deviation-prone connection route identifying unit 16 identifies the connection ID from the information received, and decides on whether the route corresponding to the connection ID is a deviation-prone connection route or not from the warning flag value corresponding to the decided connection ID among the probe information registered in the probe DB 17 (step ST6).

When it decides that the route is a deviation-prone connection route (YES at step ST6), the deviation-prone connection route identifying unit 16 extracts from the probe DB 17 a warning link ID indicating a road that can mislead the driver into a wrong route from a point corresponding to the deviation-prone connection route, and supplies it to the information returning unit 21 as the information about the deviation-prone connection route. The information returning unit 21 sends the information about the deviation-prone connection route back to the requesting mobile-body navigation device 1 via the communication interface unit 22 (step ST6).

In the mobile-body navigation device 1, the deviation-prone connection route caution instructing unit 14 has the communication device 7 receive the information about the deviation-prone connection route identified by the probe server 3 via the communication interface unit 9, and supplies the information to the map display unit 13.

The map display unit 13 displays the map and the recommended route on the screen of the display device 8 using road links of the map DB 11. In addition, the route search unit 12 executes the guide processing of the recommended route (step ST7).

Next, when the position of the vehicle obtained by the positional information acquiring unit 10 comes within the prescribed range (within the estimated arrival time or estimated distance covered, which is less than the range mentioned in the paragraph 00025) from the deviation-prone point on the deviation-prone connection route identified by the deviation-prone connection route identifying unit 16, the deviation-prone connection route caution instructing unit 14 decides that the vehicle approaches the deviation-prone point, and instructs the map display unit 13 to alter the display mode of the guide map (step ST7).

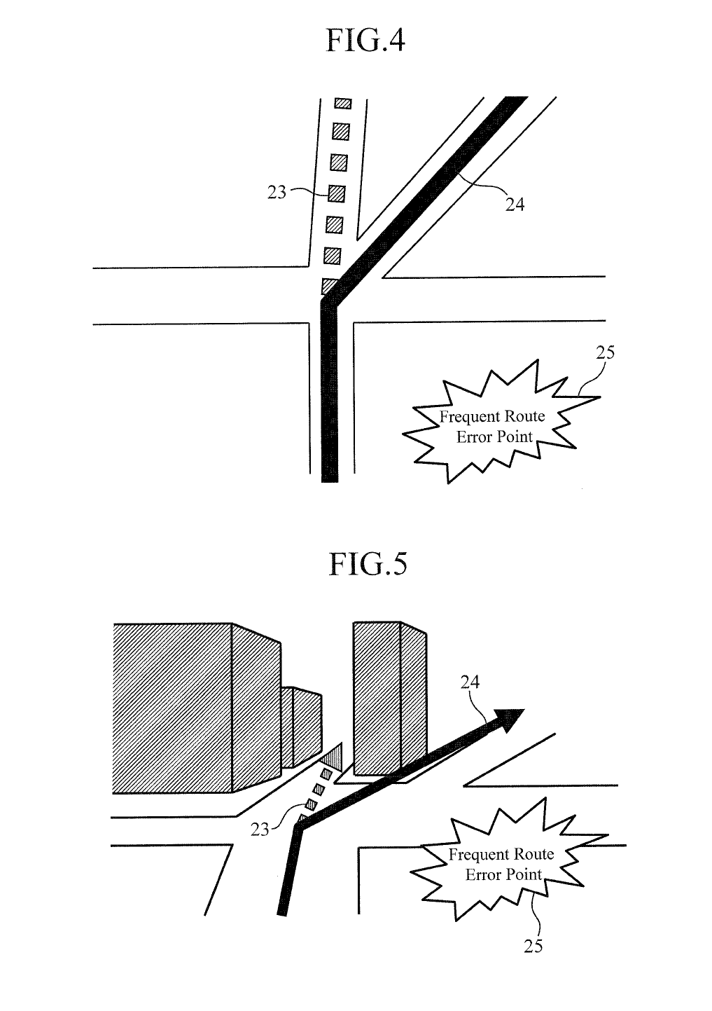

FIG. 4 is a diagram showing an example of the guide map when the vehicle approaches the deviation-prone point. FIG. 4 shows a case of using a simplified map around the intersection, which shows only roads including the deviation-prone connection route, as the guide map. When the vehicle comes near to the deviation-prone point, the guidemapas shown in FIG. 4 is displayed on the screen of the display device 8. Here, a deviation-prone road 23 and the recommended route 24 are displayed at the same time, in which the recommended route 24 is displayed emphatically, and the deviation-prone road 23 is displayed in a display mode that will draw attention of the driver.

For example, as shown in FIG. 4, the recommended route 24 is displayed using a thick line, and the deviation-prone road 23 is displayed using a broken line. In addition, the recommended route 24 is displayed in yellow, and the deviation-prone road 23 is displayed in warning color of red. The display in such a manner can distinguish the deviation-prone road 23 from the recommended route 24 clearly, and can give appropriate route guidance even at a point that can mislead the driver to a wrong route frequently.

Furthermore, when the vehicle approaches the deviation-prone point, the deviation-prone connection route caution instructing unit 14 can instruct the map display unit 13 to display on the guide map the text image information 25 with a warning message “frequent route error point”, for example. In addition, the content of the warning message can be output in voice.

FIG. 5 is another diagram showing an example of the guide map when the vehicle approaches the deviation-prone point, which shows the guide map around an intersection including the deviation-prone connection route three-dimensionally. In the example of FIG. 5, the guide map at the intersection including the deviation-prone connection route is shown as a view seen from the driver. Incidentally, although the example of the 3D display is shown, the intersection including the deviation-prone connection route can be displayed in a picture. Such a display mode can clearly show the difference between the deviation-prone road 23 and the recommended route 24, and can give appropriate route guidance at a point that can mislead the driver to a wrong route frequently.

In addition, in the same manner as FIG. 4, the text image information 25 with a warning message such as “frequent route error point” can be displayed on the guide map, and the content of the warning message can be output in voice.

As described above, according to the present embodiment 1, it comprises the communication device 7 and communication interface unit 9 which constitute a receiving unit for receiving the information about the deviation-prone connection route on the route identified in accordance with the probe information; the deviation-prone connection route caution instructing unit 14 for instructing to send a notification when the vehicle approaches the deviation-prone connection point on the guide route in accordance with the information about the deviation-prone connection route the receiving unit receives; and the display device 8 and the map display unit 13 which constitute the display unit for displaying the guide map of the guide route in response to the instructions. The embodiment with the configuration can give appropriate route guidance at the point that can often mislead a user into a wrong route. For example, in a real road environment, there are some cases where a vehicle depart from the guide route even if the driver wants to travel in accordance with the guidance of the navigation system. In view of this, the present embodiment identifies a point that can cause the deviation frequently as a deviation-prone connection route from the probe information of other vehicles, and displays a guide map showing the route to a deviation destination at the deviation-prone point. This makes it possible to call user's attention to the deviation-prone connection route, thereby being able to easily prevent the deviation from the guide route.

In addition, according to the present embodiment 1, since the guide map displayed when the vehicle is approaching the deviation-prone point is a guide map that displays a scene seen from the driver of the vehicle, it is more real than a plane map. Accordingly, the driver can easily distinguish the guide route from the route to the deviation destination. Thus the present embodiment can improve the deviation avoidance effect.

Furthermore, according to the present embodiment 1, since the guide map displayed when the vehicle is approaching the deviation-prone point is a guide map that displays the guide route and the deviation-prone route in a different display mode at the same time, the driver can easily distinguish the guide route from the deviation-prone route. Accordingly, the present embodiment can improve the deviation avoidance effect. For example, the correct guide route and the deviation-prone route can be clearly distinguished by displaying them in different colors.

Furthermore, according to the present embodiment 1, the mobile-body navigation system comprises the mobile-body navigation device 1 described above, and the probe server 3 including the deviation-prone connection route identifying unit 16 for identifying the deviation-prone connection route on the route by collecting the probe information, and the information returning unit 21 for sending the information about the deviation-prone connection route identified by the deviation-prone connection route identifying unit 16 back to the mobile-body navigation device 1. In this way, the probe server 3 identifies the deviation-prone connection route from the information obtained from the probe information. Accordingly, it can provide more reliable information.

Furthermore, according to the present embodiment 1, the deviation-prone connection route identifying unit 16 identifies the deviation-prone connection route on the route from the number of times of passing through the guide route and the number of times passing through the route other than the guide route owing to an error of the driver at the route connection acquired from the probe information. As for the route deviations, they are separated into an intentional deviation and an erroneous deviation by a user. Since the deviation-prone connection route is a connection that can mislead the driver into a wrong route, both the deviations are separated and only the erroneous deviations are counted. This makes it possible to provide more reliable information about a deviation-prone connection route.

Although the foregoing embodiment 1 shows an example that applies the mobile-body navigation device 1 in accordance with the present invention to an onboard navigation device, it is applicable not only to an onboard device, but also to a mobile phone terminal or portable information terminal (PDA: Personal Digital Assistance).

In addition, it can also be applied to a PND (Portable Navigation Device) a person brings into a mobile body such as a vehicle, train, ship or aircraft to use.

Incidentally, it is to be understood that variations of any components of the individual embodiments or removal of any components of the individual embodiments are possible within the scope of the present invention.

### INDUSTRIAL APPLICABILITY

A mobile-body navigation device in accordance with the present invention can give appropriate route guidance at a point that can mislead a user into a wrong route frequently. Accordingly, it is suitable for an onboard navigation device.

### DESCRIPTION OF REFERENCE SYMBOLS

1 mobile-body navigation device, 2 vehicle, 3 probe server, 4 communication network, 5 navigation processing unit, 6 GPS receiver, 7 communication device, 8 display device, 8a input unit, 9 communication interface unit, 10 positional information acquiring unit, 11 map database (DB), 12 route search unit, 13 map display unit, 14 deviation-prone connection route caution instructing unit, 15 probe information processing unit, 16 deviation-prone connection route identifying unit, 17 probe database (DB), 18 probe DB access unit, 19 probe data acquiring unit, 20 terminal information processing unit, 21 information returning unit, 22 communication interface unit.

1.-6. (canceled)

7. A mobile-body navigation device comprising:
a positional information acquiring unit that acquires positional information of a mobile body;
a route searching unit that searches for a recommended route using map data recorded in a map database, and the positional information and destination of the mobile body;
a communication device for transmitting, when the positional information of the mobile body comes within a prescribed range from a next connection point while the mobile body is moving along the recommended route, information about the connection to a server, and for receiving information about a deviation-prone connection route transmitted from the server in accordance with the information about the connection; and
a map display controller that causes a display device to display the information about the deviation-prone connection route.

8. The mobile-body navigation device according to claim 7, wherein the map display controller displays on the display device the recommended route and a deviation-prone road on the deviation-prone connection route at the same time, displays the recommended route emphatically, and displays the deviation-prone road in a display mode that will call attention of a driver.

9. A route display method of displaying a recommended route of a mobile body on a display device, the route display method comprising:
a step of acquiring positional information of the mobile body;
a step of searching for the recommended route using map data, and the positional information and destination of the mobile body;
a step of transmitting, when the positional information of the mobile body comes within a prescribed range from a next connection point while the mobile body is moving along the recommended route, information about the connection to a server;
a step of receiving information about a deviation-prone connection route transmitted from the server in accordance with the information about the connection; and
a step of causing a display device to display the information about the deviation-prone connection route.

10. A server for carrying out communication with a navigation device mounted on a mobile body, the server comprising:
a database for storing information about a deviation-prone connection route of the mobile body; and
a communication interface for receiving information about a connection transmitted from the navigation device when positional information of the mobile body comes within a prescribed range from a next connection point while the mobile body is moving along a recommended route, and for transmitting, when receiving the information about the connection, the information about the deviation-prone connection route to the navigation device.

11. The server according to claim 10, wherein the database stores the information about the deviation-prone connection route of the mobile body in accordance with each time period and each weather.

12. A navigation system including a navigation device mounted in a mobile body and a server for carrying out communication with the navigation device, wherein
the server comprises:
a database for storing information about a deviation-prone connection route of the mobile body; and
a communication interface for receiving information about a connection transmitted from the navigation device when positional information of the mobile body comes within a prescribed range from a next connection point while the mobile body is moving along a recommended route, and for transmitting, when receiving the information about the connection, the information about the deviation-prone connection route to the navigation device, and wherein
the navigation device comprises:
a positional information acquiring unit that acquires positional information of a mobile body;
a route searching unit that searches for a recommended route using map data recorded in a map database, and the positional information and destination of the mobile body;
a communication device for transmitting, when the positional information of the mobile body comes within a prescribed range from a next connection point while the mobile body is moving along the recommended route, information about the connection to a server, and for receiving information about a deviation-prone connection route transmitted from the server in accordance with the information about the connection; and
a map display controller that causes a display device to display the information about the deviation-prone connection route.

13. A server for carrying out communication with a navigation device mounted on a mobile body, the server comprising:
a database for storing information about a deviation-prone connection route of the mobile body in accordance with each time period and each weather; and
a communication interface for transmitting the information about the deviation-prone connection route to the navigation device.

14. A navigation system including a navigation device mounted in a mobile body and a server for carrying out communication with the navigation device, wherein
the server comprises:
a database for storing information about a deviation-prone connection route of the mobile body in accordance with each time period and each weather; and
a communication interface for transmitting the information about the deviation-prone connection route to the navigation device, and wherein
the navigation device comprises:
a positional information acquiring unit that acquires positional information of a mobile body;
a route searching unit that searches for a recommended route using map data recorded in a map database, and the positional information and destination of the mobile body;
a communication device for receiving information about the deviation-prone connection route transmitted from the server; and
a map display controller that causes a display device to display the information about the deviation-prone connection route.

15. A mobile-body navigation device comprising:
a positional information acquiring unit that acquires positional information of a mobile body;
a route searching unit that searches for a recommended route using map data recorded in a map database, and the positional information and destination of the mobile body;
a communication device for receiving information about a deviation-prone connection route transmitted from the server; and
a map display controller that displays on a display device the recommended route and a deviation-prone road on the deviation-prone connection route at the same time, for displaying the recommended route emphatically, and for displaying the deviation-prone road in a display mode that will call attention of a driver.

16. A route display method of displaying a recommended route of a mobile body on a display device, the route display method comprising:
a step of acquiring positional information of the mobile body;
a step of searching for the recommended route using map data, and the positional information and destination of the mobile body;
a step of receiving information about a deviation-prone connection route transmitted from a server; and
a step of displaying on a display device the recommended route and a deviation-prone road on the deviation-prone connection route at the same time, of displaying the recommended route emphatically, and of displaying the deviation-prone road in a display mode that will call attention of a driver.

17. A navigation system including a navigation device mounted in a mobile body and a server for carrying out communication with the navigation device, wherein
the server comprises:
a database for storing information about a deviation-prone connection route of the mobile body; and
a communication interface for transmitting the information about the deviation-prone connection route to the navigation device, and wherein
the navigation device comprises:
a positional information acquiring unit that acquires positional information of the mobile body;
a route searching unit that searches for a recommended route using map data recorded in a map database, and the positional information and destination of the mobile body;
a communication device for receiving information about the deviation-prone connection route transmitted from the server; and
a map display controller that displays on a display device the recommended route and a deviation-prone road on the deviation-prone connection route at the same time, for displaying the recommended route emphatically, and for displaying the deviation-prone road in a display mode that will call attention of a driver.
